(19) United States
(12) Patent Application Publication
(10) Pub. No.: US 2024/0240008 A1
(43) Pub. Date: Jul. 18, 2024

(54) RESIN COMPOSITION

(71) Applicants: HYUNDAI MOTOR COMPANY, Seoul (KR); Kia Corporation, Seoul (KR); LG CHEM, LTD., Seoul (KR)

(72) Inventors: Min Jin CHOI, Bucheon-si (KR); Choon Ho LEE, Hwaseong-si (KR); Woo Chul JUNG, Bucheon-si (KR); Kyoung Sil LEE, Seoul (KR); Hyun Jun RYU, Daejeon (KR); Suk Jo CHOI, Daejeon (KR); Myoung Jun LIM, Daejeon (KR); Tae Hoon KIM, Daejeon (KR)

(73) Assignees: HYUNDAI MOTOR COMPANY, Seoul (KR); Kia Corporation, Seoul (KR); LG CHEM, LTD., Seoul (KR)

(21) Appl. No.: 18/368,964

(22) Filed: Sep. 15, 2023

(30) Foreign Application Priority Data
Jan. 13, 2023 (KR) 10-2023-0005555

(51) Int. Cl. C08L 33/06; C08K 5/18; C08K 5/3447; C08L 25/16; C09B 67/20; C09B 67/22

(52) U.S. Cl. CPC C08L 33/062; C08K 5/18; C08K 5/3447; C08L 25/16; C09B 67/0033; C09B 67/0063; C08L 2205/025; C08L 2205/035

(57) ABSTRACT

The present disclosure relates to a resin composition and relates to a resin composition having excellent heat resistance and impact resistance and accomplishing the high degree of blackness.

### CROSS-REFERENCE TO RELATED APPLICATION

The present application claims priority to Korean Patent Application No. 10-2023-0005555, filed on Jan. 13, 2023, the entire contents of which are incorporated herein for all purposes by this reference.

### TECHNICAL FIELD

The present disclosure relates to a resin composition.

### BACKGROUND

Acrylonitrile-styrene-acrylate (ASA) resins are provided with all kinds of impact resistance, flowability, heat resistance, or the like, while improving weather resistance and chemical resistance, which are the biggest drawbacks of acrylonitrile-butadiene-styrene (ABS) resins, and are widely used in various usages including cars, electrical and electronic fields, office equipment, electronic goods, toys, stationery, or the like.

Recently, automobile manufacturers are trying to use ASA resins which have excellent impact resistance, flowability, heat resistance, weather resistance and chemical resistance and by which a painting process may be omitted, for increasing cost competitiveness and simultaneously accomplishing ASA resins with high blackness for improving the luxurious feeling of molded articles.

However, the conventional heat resistant ASA resins used as the exterior materials of automobiles, have inferior compatibility with a dye and have limitations in accomplishing high blackness. To overcome the drawbacks, a method of adding a polymethyl methacrylate (PMMA)-based resin to the ASA resin has been suggested, but in this case, heat resistance is weak, and reliability evaluation on main automobile parts is not satisfied.

Accordingly, the development of an ASA resin accomplishing high blackness to satisfy the needs of automobile manufacturers as well as excellent impact resistance, flowability and heat resistance, is required.

### SUMMARY

The tasks for solving of the present disclosure is to provide a resin composition having excellent heat resistance and impact resistance and accomplishing high degree of blackness, and a method of preparing the same.

In order to solve the above tasks, the present disclosure provides a resin composition.

(1) The present disclosure provides a resin composition including: a graft copolymer; and a matrix copolymer, wherein the graft copolymer includes: a first graft copolymer including an acrylic polymer having an average particle diameter of 200 nm to 650 nm, an aromatic vinyl-based monomer unit and a vinylcyan-based monomer unit; and a second graft copolymer including an acrylic polymer having an average particle diameter of 50 nm to 100 nm, an aromatic vinyl-based monomer unit and a vinylcyan-based monomer unit, the matrix copolymer includes a first matrix copolymer including an alkyl-substituted aromatic vinyl-based monomer unit, an alkyl (meth)acrylate monomer unit, and a vinylcyan-based monomer unit, and the first graft copolymer is included in 1 part by weight to 15 parts by weight, the second graft copolymer is included in 16 parts by weight to 40 parts by weight, and the first matrix copolymer is included in 40 parts by weight to 70 parts by weight, based on 100 parts by weight of the graft copolymer and the matrix copolymer.

(2) The present disclosure provides the resin composition of (1), wherein a refractive index difference between the second graft copolymer and the first matrix copolymer is 0.1 or less.

(3) The present disclosure provides the resin composition of any one of (1) or (2), wherein a refractive index difference between the second graft copolymer and the first matrix copolymer is 0.02 or less.

(4) The present disclosure provides the resin composition of any one among (1) to (3), wherein based on the weight of the first matrix copolymer itself, the first matrix copolymer includes: the alkyl-substituted aromatic vinyl-based monomer unit in 35 wt % to 40 wt %, the alkyl (meth)acrylate monomer unit in 40 wt % to 50 wt %, and the vinylcyan-based monomer unit in 17 wt % to 22 wt %.

(5) The present disclosure provides the resin composition of any one among (1) to (4), wherein the first matrix copolymer includes a copolymer of α-methylstyrene, methyl methacrylate, and acrylonitrile.

(6) The present disclosure provides the resin composition of any one among (1) to (5), wherein the matrix copolymer further includes a second matrix copolymer including an alkyl-unsubstituted aromatic vinyl-based monomer unit, an alkyl (meth)acrylate monomer unit and a vinylcyan-based monomer unit.

(7) The present disclosure provides the resin composition of any one among (1) to (6), wherein the second matrix copolymer is included in 5 parts by weight to 30 parts by weight based on 100 parts by weight of the graft copolymer and the matrix copolymer.

(8) The present disclosure provides the resin composition any one among (1) to (7), wherein the second matrix copolymer includes a copolymer of styrene, methyl methacrylate and acrylonitrile.

(9) The present disclosure provides the resin composition of any one among (1) to (8), wherein the resin composition further includes a colorant.

(10) The present disclosure provides the resin composition of any one among (1) to (9), wherein the colorant includes a mixture of anthraquinone and perinone.

(11) The present disclosure provides the resin composition of any one among (1) to (10), wherein the resin composition does not include an alkyl (meth)acrylate polymer.

The resin composition according to the present disclosure has excellent heat resistance, flowability and impact resistance, does not undergo a separate painting process to provide economic advantages and accomplishes high degree of blackness.

### DETAILED DESCRIPTION

Hereinafter, the present disclosure will be described in more detail to assist the understanding of the present disclosure.

It will be understood that words or terms used in the description and claims of the present disclosure shall not be interpreted as the meaning defined in commonly used dictionaries. It will be understood that the words or terms should be interpreted as having a meaning that is consistent with their meaning in the technical idea of the disclosure, based on the principle that an inventor may properly define the meaning of the words to best explain the disclosure.

The term “monomer unit” used in the present disclosure may represent a component or a structure derived from the monomer or the material itself, in a particular embodiment, may mean a repeating unit formed in a polymer during the polymerization of a polymer through the participation of the monomer injected in the polymerization reaction.

The term “composition” used in the present disclosure includes a reaction product and a decomposition product formed from the materials of the corresponding composition, as well as a mixture of materials including the corresponding composition.

The term “copolymerization” in the present disclosure may mean block copolymerization, random copolymerization, graft copolymerization or alternating copolymerization, unless otherwise defined, and the term “copolymer” may mean a block copolymer, a random copolymer, a graft copolymer or an alternating copolymer.

In the present disclosure, the average particle diameter of an acrylic polymer may be measured using a dynamic light scattering method, particularly, using a Nicomp 380 HPL equipment (product name, manufacturer: Nicomp), for example.

In the present description, an average particle diameter means an arithmetic average particle diameter in particle size distribution measured by a light scattering method, i.e., a scattering intensity average particle diameter.

In the present disclosure, the weight average molecular weight of a matrix copolymer may be measured through gel permeation chromatography using tetrahydrofuran as an eluent, as a relative value with respect to a standard specimen of poly(methyl methacrylate) of Polymer Laboratories Co.

In the present disclosure, the refractive indexes of the graft copolymer and the matrix copolymer were measured at 25° C. using an Abbe refractometer based on ASTM D542.

### <Resin Composition>

The present disclosure provides a resin composition.

The resin composition according to an embodiment of the present disclosure includes a graft copolymer and a matrix copolymer. The graft copolymer includes a first graft copolymer including an acrylic polymer having an average particle diameter of 200 nm to 650 nm, an aromatic vinyl-based monomer unit and a vinylcyan-based monomer unit; and a second graft copolymer including an acrylic polymer having an average particle diameter of 50 nm to 100 nm, an aromatic vinyl-based monomer unit and a vinylcyan-based monomer unit. The matrix copolymer includes a first matrix copolymer including an alkyl-substituted aromatic vinyl-based monomer unit, an alkyl (meth)acrylate monomer unit, and a vinylcyan-based monomer unit. The first graft copolymer is included in 1 part by weight to 15 parts by weight, the second graft copolymer is included in 16 parts by weight to 40 parts by weight, and the first matrix copolymer is included in 40 parts by weight to 70 parts by weight, based on 100 parts by weight of the graft copolymer and the matrix copolymer.

According to the configuration, the resin composition may not include polymethyl methacrylate which degrades heat resistance, and accordingly, the resin composition may show improved heat resistance, flowability and impact resistance and may accomplish the high degree of blackness.

Hereinafter, the components included in the resin composition will be explained in particular.

### 1. Graft Copolymer

According to an embodiment of the present disclosure, a graft copolymer may be an ASA resin prepared by graft polymerization of an aromatic vinyl-based monomer and a vinylcyan-based monomer into an acrylic polymer.

According to an embodiment of the present disclosure, the graft copolymer includes a first graft copolymer including an acrylic polymer having an average particle diameter of 200 nm to 650 nm, an aromatic vinyl-based monomer unit and a vinylcyan-based monomer unit, and a second graft copolymer including an acrylic polymer having an average particle diameter of 50 nm to 100 nm, an aromatic vinyl-based monomer unit and a vinylcyan-based monomer unit. In this case, the heat resistance, flowability and impact resistance of the resin composition may be improved and the high degree of blackness may be accomplished simultaneously when compared to a case of including one type of a graft copolymer.

### (1-1) First Graft Copolymer

According to an embodiment of the present disclosure, the first graft copolymer is a part of the resin composition and may be a resin for providing the resin composition with basic physical properties. For example, the first graft copolymer may provide the resin composition with suitable impact strength and flowability index.

According to an embodiment of the present disclosure, the first graft copolymer may include an acrylic polymer, an aromatic vinyl-based monomer unit and a vinylcyan-based monomer unit. In a particular embodiment, the acrylic polymer may be prepared by the polymerization of an acrylic monomer and may include an acrylic monomer unit.

According to an embodiment of the present disclosure, the acrylic monomer for forming the acrylic monomer unit of the acrylic polymer of the first graft copolymer may be C₄-C₁₀ alkyl (meth)acrylate monomer, particularly, one or more selected from the group consisting of butyl (meth)acrylate, pentyl (meth)acrylate, hexyl (meth)acrylate, heptyl (meth)acrylate, octyl (meth)acrylate, ethylhexyl (meth)acrylate, nonyl (meth)acrylate, isononyl (meth)acrylate and decyl (meth)acrylate, more particularly, butyl acrylate.

According to an embodiment of the present disclosure, the first graft copolymer may be obtained by the graft polymerization of the aromatic vinyl-based monomer unit and the vinylcyan-based monomer unit into the acrylic polymer.

Accordingly, the first graft copolymer may include the acrylic polymer and the aromatic vinyl-based monomer unit and the vinylcyan-based monomer unit, grafted into the acrylic polymer, and according to graft polymerization conditions, the vinyl-based monomer unit and the vinylcyan-based monomer unit, ungrafted into the acrylic polymer may be included together in a portion where the graft layer of the graft copolymer is formed. In this case, the graft polymerization may be performed by emulsion polymerization or bulk polymerization.

According to an embodiment of the present disclosure, the aromatic vinyl-based monomer for forming the aromatic vinyl-based monomer unit of the first graft copolymer may be one or more selected from the group consisting of styrene, α-methylstyrene, 3-methylstyrene, 4-methylstyrene, 4-propylstyrene, 1-vinylnaphthalene, 4-cyclohexylstyrene, 4-(p-methylphenyl)styrene and 1-vinyl-5-hexylnaphthalene, particularly, styrene.

According to an embodiment of the present disclosure, the vinylcyan-based monomer for forming the vinylcyan-based monomer unit of the first graft copolymer may be one or more selected from the group consisting of acrylonitrile, methacrylonitrile, ethacrylonitrile, phenylacrylonitrile and α-chloroacrylonitrile, particularly, acrylonitrile.

According to an embodiment of the present disclosure, the C₄-C₁₀ alkyl (meth)acrylate monomer may be injected in 35 wt % to 55 wt %, or 40 wt % to 55 wt %, more particularly, 50 wt % to 55 wt %, based on the total weight of the monomers injected during the preparation of the first graft copolymer. If the above-described range is satisfied, the weather resistance, impact resistance, surface gloss properties, elongation rate and whitening properties of the first graft copolymer may be improved even further.

According to an embodiment of the present disclosure, the aromatic vinyl-based monomer may be injected in 30 wt % to 50 wt %, or 35 wt % to 45 wt %, more particularly, 35 wt % to 45 wt % based on the total weight of the monomers injected during the preparation of the first graft copolymer. If the above-described range is satisfied, the processability of the first graft copolymer may be improved even further, the first graft copolymer may be dispersed in the resin composition even more uniformly, and the coloring of the resin composition may be improved even further.

According to an embodiment of the present disclosure, the vinylcyan-based monomer may be injected in 10 wt % to 30 wt %, or 10 wt % to 25 wt %, more particularly, 10 wt % to 20 wt % based on the total weight of the monomers injected during the preparation of the first graft copolymer. If the above-described range is satisfied, the chemical resistance of the first graft copolymer may be improved even further, the first graft copolymer may be dispersed in the resin composition even more uniformly, and the coloring of the resin composition may be improved even further.

According to an embodiment of the present disclosure, the acrylic polymer included in the first graft copolymer may have an average particle diameter of 200 nm to 650 nm. In a particular embodiment, the average particle diameter of the acrylic polymer may be 200 nm or more, 250 nm or more, 300 nm or more, 350 nm or more, or 450 nm or more, and 650 nm or less, 600 nm or less, 550 nm or less, or 500 nm or less. If the above-described range is satisfied, suitable impact strength and flowability index may be provided for the resin composition. If the average particle diameter of the acrylic polymer is less than 200 nm, the impact strength and flowability index of the resin composition may be markedly deteriorated.

According to an embodiment of the present disclosure, the first graft copolymer may be included in 1 part by weight to 15 parts by weight based on 100 parts by weight of the graft copolymer and the matrix copolymer of the resin composition. In a particular embodiment, the first graft copolymer may be included in 1 part by weight or more, 3 parts by weight or more, or 5 parts by weight or more, and 15 parts by weight or less, 13 parts by weight or less, or 10 parts by weight or less based on 100 parts by weight of the graft copolymer and the matrix copolymer. If the above-described range is satisfied, suitable impact strength and flowability index may be provided for the resin composition. If the first graft copolymer is included in less than 1 part by weight based on 100 parts by weight of the graft copolymer and the matrix copolymer, the impact strength and flowability index of the resin composition may be markedly degraded, and if included in greater than 15 parts by weight based on 100 parts by weight of the graft copolymer and the matrix copolymer, the degree of blackness of the resin composition achieved may be markedly degraded.

### (1-2) Second Graft Copolymer

According to an embodiment of the present disclosure, the second graft copolymer is a part of the resin composition and may improve the degree of blackness achieved by the resin composition.

According to an embodiment of the present disclosure, the second graft copolymer may include an acrylic polymer, an aromatic vinyl-based monomer unit and a vinylcyan-based monomer unit. In a particular embodiment, the acrylic polymer may be prepared by the polymerization of an acrylic monomer and may include an acrylic monomer unit.

According to an embodiment of the present disclosure, the acrylic monomer for forming the acrylic monomer unit of the acrylic polymer of the second graft copolymer may be within the same category as the type of the acrylic monomer included in (1-1) First Graft Copolymer of the present description.

According to an embodiment of the present disclosure, the second graft copolymer may be obtained by the graft polymerization of the aromatic vinyl-based monomer unit and the vinylcyan-based monomer unit into the acrylic polymer.

Accordingly, the second graft copolymer may include the acrylic polymer, and the aromatic vinyl-based monomer unit and the vinylcyan-based monomer unit, grafted into the acrylic polymer, and according to graft polymerization conditions, the vinyl-based monomer unit and the vinylcyan-based monomer unit, ungrafted into the acrylic polymer may be included together in a portion where the graft layer of the graft copolymer is formed. In this case, the graft polymerization may be performed by emulsion polymerization or bulk polymerization.

According to an embodiment of the present disclosure, the aromatic vinyl-based monomer for forming the aromatic vinyl-based monomer unit of the second graft copolymer may be within the same category as the type of the aromatic vinyl-based monomer included in (1-1) First Graft Copolymer of the present description.

According to an embodiment of the present disclosure, the vinylcyan-based monomer for forming the vinylcyan-based monomer unit of the second graft copolymer may be within the same category as the type of the vinylcyan-based monomer included in (1-1) First Graft Copolymer of the present description.

According to an embodiment of the present disclosure, the C₄-C₁₀ alkyl (meth)acrylate monomer may be injected in 30 wt % to 50 wt %, or 32 wt % to 47 wt %, more particularly, 35 wt % to 45 wt % based on the total weight of the monomers injected during the preparation of the second graft copolymer. If the above-described range is satisfied, the weather resistance, impact resistance, surface gloss properties, elongation rate and whitening properties of the second graft copolymer may be improved even further.

According to an embodiment of the present disclosure, the aromatic vinyl-based monomer may be injected in 30 wt % to 50 wt %, or 35 wt % to 50 wt %, more particularly, 40 wt % to 50 wt % based on the total weight of the monomers injected during the preparation of the second graft copolymer. If the above-described range is satisfied, the processability of the second graft copolymer may be improved even further, the second graft copolymer may be dispersed in the resin composition even more uniformly, and the coloring of the resin composition may be improved even further.

According to an embodiment of the present disclosure, the vinylcyan-based monomer may be injected in 10 wt % to 30 wt %, or 10 wt % to 25 wt %, more particularly, 10 wt % to 20 wt % based on the total weight of the monomers injected during the preparation of the second graft copolymer. If the above-described range is satisfied, the chemical resistance of the second graft copolymer may be improved even further, the second graft copolymer may be dispersed in the resin composition even more uniformly, and the coloring of the resin composition may be improved even further.

According to an embodiment of the present disclosure, the acrylic polymer included in the second graft copolymer may have an average particle diameter of 50 nm to 100 nm. In a particular embodiment, the average particle diameter of the acrylic polymer may be 50 nm or more, 55 nm or more, 60 nm or more, 65 nm or more, 75 nm or more, or 80 nm or more, and 100 nm or less, 98 nm or less, 95 nm or less, 93 nm or less, or 90 nm or less. If the above-described range is satisfied, the coloring of the resin composition may be improved, and the degree of blackness accomplished of the resin composition may be improved. For example, if the average particle diameter of the acrylic polymer is greater than 100 nm, the degree of blackness accomplished of the resin composition may be markedly deteriorated.

According to an embodiment of the present disclosure, the second graft copolymer may be included in 16 parts by weight to 38 parts by weight based on 100 parts by weight of the graft copolymer and the matrix copolymer of the resin composition. In a particular embodiment, the second graft copolymer may be included in 16 parts by weight or more, 18 parts by weight or more, or 20 parts by weight or more, and 38 parts by weight or less, 36 parts by weight or less, 34 parts by weight or less, 32 parts by weight or less, or 30 parts by weight or less based on 100 parts by weight of the graft copolymer and the matrix copolymer of the resin composition. If the above-described range is satisfied, the coloring of the resin composition may be improved. If the second graft copolymer is included in less than 16 parts by weight based on 100 parts by weight of the graft copolymer and the matrix copolymer, the degree of blackness accomplished of the resin composition may be markedly degraded, and if included in greater than 38 parts by weight based on the graft copolymer and the matrix copolymer, the impact strength and flowability index of the resin composition may be markedly degraded.

According to an embodiment of the present disclosure, a refractive index of the second graft copolymer may be 1.48 to 1.55, or 1.49 to 1.54, more particularly, 1.50 to 1.53. If the above-described range is satisfied, a refractive index difference with a matrix copolymer, which will be explained later, may be reduced to improve the degree of blackness accomplished of the resin composition.

### 2. Matrix Copolymer

According to an embodiment of the present disclosure, the matrix copolymer is a part of the resin composition and may be a matrix resin. According to an embodiment of the present disclosure, the matrix copolymer is a random copolymer and includes an alkyl (meth)acrylate monomer unit, an aromatic vinyl-based monomer unit and a vinylcyan-based monomer unit.

According to an embodiment of the present disclosure, the matrix copolymer may be a copolymer of a mixture of an alkyl (meth)acrylate monomer, an aromatic vinyl-based monomer and a vinylcyan-based monomer unit.

The aromatic vinyl-based monomer unit and the vinylcyan-based monomer unit included in the matrix copolymer are the constituting elements of the graft copolymer, and may improve the utilization of the graft copolymer included in the matrix copolymer. Accordingly, the resin composition according to an embodiment of the present disclosure does not induce phase separation during molding even at a high temperature. In addition, the matrix copolymer may improve the coloring, weather resistance and hardness of the resin composition.

### (2-1) First Matrix Copolymer

The matrix copolymer includes a first matrix copolymer including an alkyl-substituted aromatic vinyl-based monomer unit, an alkyl (meth)acrylate monomer unit and a vinylcyan-based monomer unit.

According to an embodiment of the present disclosure, the alkyl-substituted aromatic vinyl-based monomer for forming the alkyl-substituted aromatic vinyl-based monomer unit of the first matrix copolymer may be the above-described aromatic vinyl-based monomer of which one or more hydrogen are substituted with alkyl groups, particularly, one or more selected from the group consisting of α-methylstyrene, p-methylstyrene and 2,4-dimethylstyrene, more particularly, α-methylstyrene.

According to an embodiment of the present disclosure, the alkyl (meth)acrylate monomer for forming the alkyl (meth)acrylate monomer unit of the first matrix copolymer may be a C₁-C₃ alkyl (meth)acrylate monomer, and particular examples of the C₁-C₃ alkyl (meth)acrylate monomer may be one or more selected from the group consisting of methyl (meth)acrylate, ethyl (meth)acrylate and propyl (meth)acrylate, more particularly, methyl methacrylate.

According to an embodiment of the present disclosure, the vinylcyan-based monomer for forming the vinylcyan-based monomer unit of the first matrix copolymer may be one or more selected from the group consisting of acrylonitrile, methacrylonitrile, ethacrylonitrile, phenylacrylonitrile and α-chloroacrylonitrile, more particularly, acrylonitrile.

According to an embodiment of the present disclosure, the first matrix copolymer may be a copolymer of a mixture of an alkyl-substituted aromatic vinyl-based monomer, an alkyl (meth)acrylate monomer and a vinylcyan-based monomer.

According to an embodiment of the present disclosure, the first matrix copolymer may include the alkyl-substituted aromatic vinyl-based monomer unit in 35 wt % to 40 wt %, based on the weight of the first matrix copolymer itself. In a particular embodiment, the first copolymer may include the alkyl-substituted aromatic vinyl-based monomer unit in 35 wt % or more, 36 wt % or more, or 37 wt % or more, and 40 wt % or less, 39 wt % or less, or 38 wt % or less. If the above-described range is satisfied, the impact resistance, flowability index and heat resistance of the resin composition may be improved, and the degree of blackness accomplished of the resin composition may be improved. If the first matrix copolymer includes the alkyl-substituted aromatic vinyl-based monomer unit in greater than 40 wt %, the degree of blackness accomplished of the resin composition may markedly be degraded.

According to an embodiment of the present disclosure, the first matrix copolymer may include the alkyl (meth)acrylate monomer unit in 40 wt % to 50 wt %, based on the weight of the first matrix copolymer itself. In a particular embodiment, the first matrix copolymer may include the alkyl (meth)acrylate monomer unit in 40 wt % or more, 42 wt % or more, or 43 wt % or more, and 50 wt % or less, 48 wt % or less, or 45 wt % or less. If the above-described range is satisfied, the impact resistance, flowability and heat resistance of the resin composition may be improved, and the degree of blackness accomplished of the resin composition may be improved. If the first matrix includes the alkyl (meth)acrylate monomer unit in greater than 50 wt %, the impact strength of the resin composition may be markedly degraded.

According to an embodiment of the present disclosure, the first matrix copolymer may include the vinylcyan-based monomer unit in 17 wt % to 22 wt %, based on the weight of the first matrix copolymer itself. In a particular embodiment, the first matrix copolymer may include the vinylcyan-based monomer unit in 17 wt % or more, 18 wt % or more, or 19 wt % or more, and 22 wt % or less, 21 wt % or less, or 20 wt % or less. If the above-described range is satisfied, the impact resistance, flowability and heat resistance of the resin composition may be improved, and the degree of blackness accomplished of the resin composition may be improved.

According to an embodiment of the present disclosure, the first matrix copolymer may have a weight average molecular weight of 70,000 g/mol to 150,000 g/mol, 75,000 g/mol to 140,000 g/mol, or 80,000 g/mol to 130,000 g/mol, in a more particular embodiment, 85,000 g/mol to 110,000 g/mol. If the above-described range is satisfied, the balance of the processability, compatibility and hardness of the resin composition may be improved.

According to an embodiment of the present disclosure, the first matrix copolymer may be included in 40 parts by weight to 70 parts by weight based on 100 parts by weight of the graft copolymer and the matrix copolymer of the resin composition. In a particular embodiment, the first matrix copolymer may be included in 40 parts by weight or more, 42 parts by weight or more, or 45 parts by weight or more, and 70 parts by weight or less, 68 parts by weight or less, or 65 parts by weight or less based on 100 parts by weight of the graft copolymer and the matrix copolymer of the resin composition. If the above-described range is satisfied, the heat resistance, flowability and impact resistance of the resin composition may be improved and the high degree of blackness may be accomplished simultaneously. If the first matrix copolymer is included in greater than 70 parts by weight based on 100 parts by weight of the graft copolymer and the matrix copolymer, the impact strength of the resin composition may be markedly degraded.

According to an embodiment of the present disclosure, a difference between the refractive index of the first matrix copolymer and the refractive index of the second graft copolymer may be 0.1 or less, preferably, the same. In the present disclosure, the same refractive index includes a refractive index difference between compared refractive indexes of 0.02 or less. If the refractive index of the first matrix copolymer and the refractive index of the second graft copolymer satisfy the above-described conditions, the degree of blackness accomplished of the resin composition may be improved.

According to an embodiment of the present disclosure, the refractive index of the first matrix copolymer may be 1.50 to 1.57, or 1.51 to 1.56, more particularly, 1.52 to 1.55. If the above-described range is satisfied, the degree of blackness accomplished of the resin composition may be improved.

According to an embodiment of the present disclosure, the glass transition temperature of the first matrix copolymer may be 105° C. to 130° C., or 108° C. to 125° C., more particularly, 110° C. to 122° C. If the above-described range is satisfied, the degree of blackness accomplished of the resin composition may be improved.

### (2-2) Second Matrix Copolymer

The matrix copolymer may further include a second matrix copolymer including an alkyl-unsubstituted aromatic vinyl-based monomer unit, an alkyl (meth)acrylate monomer unit and a vinylcyan-based monomer unit.

According to an embodiment of the present disclosure, the alkyl-unsubstituted aromatic vinyl-based monomer for forming the alkyl-unsubstituted aromatic vinyl-based monomer unit of the second matrix copolymer means the aromatic vinyl-based monomer in which any hydrogen is not substituted with alkyl. In this case, the inclusion of a substituent other than an alkyl group is not excluded. The alkyl-unsubstituted aromatic vinyl-based monomer may particularly be one or more selected from the group consisting of p-bromostyrene, o-bromostyrene and p-chlorostyrene, more particularly, styrene.

According to an embodiment of the present disclosure, the alkyl (meth)acrylate monomer for forming the alkyl (meth)acrylate monomer unit of the second matrix copolymer may be within the same category as the type of the alkyl (meth)acrylate monomer included in (2-1) First Matrix Copolymer of the present description.

According to an embodiment of the present disclosure, the vinylcyan-based monomer for forming the vinylcyan-based monomer unit of the second matrix copolymer may be within the same category as the type of the vinylcyan-based monomer included in (2-1) First Matrix Copolymer of the present description.

According to an embodiment of the present disclosure, the second matrix copolymer may be a copolymer of a monomer mixture including an alkyl-unsubstituted aromatic vinyl-based monomer, an alkyl (meth)acrylate monomer and a vinylcyan-based monomer.

According to an embodiment of the present disclosure, the second matrix copolymer may include the alkyl-unsubstituted aromatic vinyl-based monomer unit in 10 wt % to 40 wt %, or 13 wt % to 35 wt %, more particularly, 15 wt % to 30 wt %. If the above-described range is satisfied, the impact resistance, flowability and heat resistance of the resin composition may be improved, and the degree of blackness accomplished of the resin composition may be improved.

According to an embodiment of the present disclosure, the second matrix copolymer may include the alkyl (meth)acrylate monomer unit in 50 wt % to 85 wt %, or 55 wt % to 83 wt %, more particularly, 60 wt % to 80 wt %. If the above-described range is satisfied, the impact resistance, flowability and heat resistance of the resin composition may be improved, and the degree of blackness accomplished of the resin composition may be improved.

According to an embodiment of the present disclosure, the second matrix copolymer may include the vinylcyan-based monomer unit in 1 wt % to 25 wt %, or 2 wt % to 20 wt %, more particularly, 3 wt % to 15 wt %. If the above-described range is satisfied, the impact resistance, flowability and heat resistance of the resin composition may be improved, and the degree of blackness accomplished of the resin composition may be improved.

According to an embodiment of the present disclosure, the second matrix copolymer may have a weight average molecular weight of 100,000 g/mol to 170,000 g/mol, 110,000 g/mol to 170,000 g/mol, or 120,000 g/mol to 170,000 g/mol, in a more particular embodiment, 140,000 g/mol to 160,000 g/mol. If the above-described range is satisfied, the balance of the processability, compatibility and hardness of the resin composition may be improved.

According to an embodiment of the present disclosure, the second matrix copolymer may be included in 5 parts by weight to 30 parts by weight, or 8 parts by weight to 25 parts by weight, more particularly, 10 parts by weight to 20 parts by weight based on 100 parts by weight of the graft copolymer and the matrix copolymer of the resin composition. If the above-described range is satisfied, the heat resistance, flowability and impact resistance of the resin composition may be improved and the high degree of blackness may be accomplished simultaneously.

According to an embodiment of the present disclosure, the refractive index of the second matrix copolymer may be 1.40 to 1.57, or 1.43 to 1.55, more particularly, 1.45 to 1.52. If the above-described range is satisfied, the degree of blackness accomplished of the resin composition may be improved.

According to an embodiment of the present disclosure, the glass transition temperature of the second matrix copolymer may be 90° C. to 120° C., or 93° C. to 115° C., more particularly, 95° C. to 110° C. If the above-described range is satisfied, the degree of blackness accomplished of the resin composition may be improved.

### (3) Colorant

The resin composition may further include a colorant. The colorant may play the role of expressing the color of the resin composition. The colorant may be a dye, a pigment, or the combination of them.

According to an embodiment of the present disclosure, the colorant may particularly include carbon black. The carbon black is a black colorant prepared by the combustion or thermal decomposition of a carbon-containing compound in an oxygen-insufficient state. The particle diameter of the carbon black may be 1 to 500 nm, particularly, 1 to 100 nm.

According to an embodiment of the present disclosure, the colorant may particularly include a carbon black master batch. The carbon black master batch is prepared by mixing carbon black, a thermoplastic resin and an additive such as a lubricant oil. The thermoplastic resin used for the preparation of the carbon black master batch may particularly be a copolymer of an aromatic vinyl-based monomer and a vinylcyan-based monomer. The explanation on the aromatic vinyl-based monomer and the vinylcyan-based monomer is the same as described above.

According to an embodiment of the present disclosure, the colorant may be a mixture of 1,4-bis(p-tolylamino)anthraquinone and perinone. In this case, the colorant may be a mixture including 1,4-bis(p-tolylamino)anthraquinone in 50 wt % to 70 wt %.

According to an embodiment of the present disclosure, the colorant may be suitably included in a range not inhibiting the physical properties of the resin composition, particularly, 0.1 parts by weight to 5 parts by weight based on 100 parts by weight of the resin composition. More particularly, 0.1 parts by weight to 3 parts by weight may be included.

### (4) Other Additives

The resin composition may further include one or more other additives to control the balance among physical properties according to the need of final use. Particularly, the other additive may use a flame retardant, a surfactant, a nucleating agent, a coupling agent, a filler, a plasticizer, an impact reinforcing agent, a lubricant, an antimicrobial, a releasing agent, an antioxidant, an inorganic additive, a lubricant oil, an antistatic agent, a flame resistant, a thermal stabilizer, a ultraviolet absorbent, a ultraviolet blocking agent, a nuclear forming agent, an adhesive, or the like, and these may be used solely or as a combination of two or more.

The other additive may be included in a range suitable for not inhibiting the physical properties of the resin composition, particularly, 40 parts by weight or less, more particularly, 0.1 to 30 parts by weight with respect to 100 parts by weight of the resin composition.

### <Method of Preparing Resin Composition>

The resin composition may be prepared by a known preparation method. For example, the constituent elements according to an embodiment and other additives may be mixed simultaneously, and then melt extruded in an extruder to form in a pellet shape.

### <Molded Article>

Using the resin composition, a molded article may be formed by various processes such as extrusion molding, blow molding, extrusion molding and compression molding. The molded article may have excellent impact resistance, flowability index and heat resistance, and though not undergoing a separate painting process, may show excellent degree of blackness accomplished of the molded article.

According to an embodiment of the present disclosure, the molded article may be the exterior material of an automobile. In this case, all of heat resistance, impact resistance, flowability, degree of blackness and economic feasibility, required on the market may be satisfied by the thermoplastic resin composition of the present description, and a molded article with high quality may be provided.

The exterior material of the automobile may be, for example, a wing mirror housing, a radiator grill, a filler, or a garnish, and may satisfy heat resistance, impact resistance and degree of blackness all, while increasing cost competitiveness in contrast to the common materials and providing economic merits, thereby satisfying the requirements of a consumer.

Hereinafter, embodiments of the present disclosure will be explained in detail so that a person skilled in this technical field in which the present disclosure belongs to may perform easily. However, the present disclosure may be embodied in various different types and is not limited to the embodiments explained herein below.

### Examples and Comparative Examples

The materials used in the Examples and Comparative Examples are as follows:
1) Graft copolymer (A1): an ASA resin having an average particle diameter of an acrylic polymer of 350 nm to 400 nm (prepared by graft polymerization of styrene and acrylonitrile into butyl acrylate rubber),
2) Graft copolymer (A2): an ASA resin having an average particle diameter of an acrylic polymer of 250 nm to 300 nm (prepared by graft polymerization of styrene and acrylonitrile into butyl acrylate rubber),
3) Graft copolymer (A3): an ASA resin having an average particle diameter of an acrylic polymer of 110 nm to 130 nm and a refractive index of 1.495 (prepared by graft polymerization of styrene and acrylonitrile into butyl acrylate rubber),
4) Graft copolymer (A4): an ASA resin having an average particle diameter of an acrylic polymer of 80 nm to 100 nm and a refractive index of 1.510 (prepared by graft polymerization of styrene and acrylonitrile into butyl acrylate rubber),
5) Matrix copolymer (B1): an AMS-MMA-AN copolymer including 35 wt % to 40 wt % of α-methylstyrene (AMS), 40 wt % to 45 wt % of methyl methacrylate (MMA), and 17 wt % to 22 wt % of acrylonitrile (AN), and having a glass transition temperature of about 120° C., a weight average molecular weight of 85,000 to 110,000 g/mol and a refractive index of 1.53,
6) Matrix copolymer (B2): an AMS-MMA-AN copolymer including 20 wt % to 30 wt % of α-methylstyrene (AMS), 60 wt % to 70 wt % of methyl methacrylate (MMA), and 25 wt % to 35 wt % of acrylonitrile (AN), and having a glass transition temperature of about 119° C., a weight average molecular weight of 85,000 to 110,000 g/mol and a refractive index of 1.52,
7) Matrix copolymer (B3): an AMS-MMA-AN copolymer including 50 wt % to 60 wt % of α-methylstyrene (AMS), 10 wt % to 20 wt % of methyl methacrylate (MMA), and 25 wt % to 35 wt % of acrylonitrile (AN), and having a glass transition temperature of about 123° C., a weight average molecular weight of 85,000 to 110,000 g/mol and a refractive index of 1.56,
8) Matrix copolymer (B4): an AMS-AN copolymer including 65 wt % to 75 wt % of α-methylstyrene (AMS), and 25 wt % to 35 wt % of acrylonitrile (AN), and having a glass transition temperature of about 124° C., a weight average molecular weight of 85,000 to 110,000 g/mol and a refractive index of 1.57,
9) Matrix copolymer (B5): an MMA-SM-AN copolymer including 65 wt % to 75 wt % of methyl methacrylate (MMA), 15 wt % to 25 wt % of styrene (SM), and 3 wt % to 10 wt % of acrylonitrile (AN), and having a glass transition temperature of about 102° C., a weight average molecular weight of 140,000 to 160,000 g/mol and a refractive index of 1.51,
10) PMMA (C): a polymethyl methacrylate having a glass transition temperature of about 113° C., a weight average molecular weight of 80,000 to 110,000 g/mol and a refractive index of 1.49, and
11) Black dye (D): a mixture of 50 wt % to 70 wt % of 1,4 bis(p-tolylamino)anthraquinone and perinone.

The above-described components were mixed in amounts shown in Table 1 to Table 3 and stirred to prepare resin compositions.

### Experimental Examples

The resin compositions prepared by mixing the above-described components in amounts shown in Table 1 to Table 3 and stirring, were injected into a kneader extruder (processing temperature: 240° C.) and extruded to form pellets.

The pellet thus formed was formed into a specimen based on ISO standard using a 120MT injection machine (processing temperature: 240° C.), and measurement was performed by methods below. A specimen for the degree of blackness was formed as a square high-gloss specimen with a thickness of 3 mm×length of 10 cm×width of 10 cm, and the degree of gloss of the high-gloss specimen measured using a GLOSS meter under 60° conditions was in a range of 85 to 95.

Izod impact strength (kJ/m², Notched, thickness of 4.0 mm, width after notch of 8 mm): Measurement was conducted at 23° C. using IMPACT TESTER of Tinius Olsen Co., based on ISO 180. Here, a high measurement value means excellent impact resistance.

Flowability index (g/10 min): A weight was measured for 10 minutes under conditions of a temperature of 220° C. and a load of 10 kg using MI-4 of GOTTER Co., based on ISO 1133-1. Here, a high measurement value means excellent flowability.

Heat deflection temperature (° C.): The heat deflection temperature was measured using Auto HDT Tester 6A-2 of TOYOSEIKI Co., based on ISO 75. Here, a high measurement value means excellent heat resistance.

Degree of blackness (L): A L value was measured in a SCE mode using Ci7800 equipment of X-rite Co. Here, the L value is a numerical judging a white-black value on a L*a*b color system, and a low L value means excellent degree of blackness.

TABLE 1

| | Example | | | | | | |
|---|---|---|---|---|---|---|---|
| Division | 1 | 2 | 3 | 4 | 5 | 6 | 7 |
| (A1) Graft copolymer | 5 | 5 | 8 | — | 9 | 10 | — |
| (parts by weight) | | | | | | | |
| (A2) Graft copolymer | — | — | — | 10 | — | — | 12 |
| (parts by weight) | | | | | | | |
| (A3) Graft copolymer | — | — | — | — | — | — | — |
| (parts by weight) | | | | | | | |
| (A4) Graft copolymer | 30 | 30 | 24 | 26 | 24 | 22 | 25 |
| (parts by weight) | | | | | | | |
| (B1) Matrix copolymer | 65 | 55 | 50 | 60 | 55 | 49 | 53 |
| (parts by weight) | | | | | | | |
| (B2) Matrix copolymer | — | — | — | — | — | — | — |
| (parts by weight) | | | | | | | |
| (B3) Matrix copolymer | — | — | — | — | — | — | — |
| (parts by weight) | | | | | | | |
| (B4) Matrix copolymer | — | — | — | — | — | — | — |
| (parts by weight) | | | | | | | |
| (B5) Matrix copolymer | — | 10 | 18 | 4 | 12 | 19 | 10 |
| (parts by weight) | | | | | | | |
| (C) PMMA (parts by | — | — | — | — | — | — | — |
| weight) | | | | | | | |
| (D) Black dye (parts | 1 | 1 | 1 | 1 | 1 | 1 | 1 |
| by weight) | | | | | | | |
| Izod impact strength | 7.1 | 7.0 | 8.2 | 7.7 | 8.4 | 8.5 | 7.8 |
| (kJ/m² ) | | | | | | | |
| Flowability index | 8.3 | 8.7 | 7.7 | 8.1 | 7.7 | 7.9 | 7.2 |
| (g/10 min) | | | | | | | |
| Heat deflection | 82 | 79 | 79 | 81 | 81 | 80 | 80 |
| temperature (° C.) | | | | | | | |
| Degree of blackness | 1.9 | 1.7 | 2.2 | 1.9 | 2.1 | 2.3 | 1.3 |
| (L, SCE) | | | | | | | |

TABLE 2

| | Comparative Example | | | | | | | |
|---|---|---|---|---|---|---|---|---|
| Division | 1 | 2 | 3 | 4 | 5 | 6 | 7 | 8 |
| (A1) Graft | — | — | 9 | 8 | 10 | 8 | 5 | 20 |
| copolymer | | | | | | | | |
| (parts by weight) | | | | | | | | |
| (A2) Graft | 9 | 9 | — | — | — | — | — | — |
| copolymer | | | | | | | | |
| (parts by weight) | | | | | | | | |
| (A3) Graft | 23 | 23 | 24 | — | — | — | — | — |
| copolymer | | | | | | | | |
| (parts by weight) | | | | | | | | |
| (A4) Graft | — | — | — | 24 | 22 | 24 | 20 | 15 |
| copolymer | | | | | | | | |
| (parts by weight) | | | | | | | | |
| (B1) Matrix | — | 30 | 55 | 50 | — | — | 75 | 65 |
| copolymer | | | | | | | | |
| (parts by weight) | | | | | | | | |
| (B2) Matrix | — | — | — | — | — | — | — | — |
| copolymer | | | | | | | | |
| (parts by weight) | | | | | | | | |
| (B3) Matrix | — | — | — | — | — | — | — | — |
| copolymer | | | | | | | | |
| (parts by weight) | | | | | | | | |
| (B4) Matrix | — | — | — | — | — | 50 | — | — |
| copolymer | | | | | | | | |
| (parts by weight) | | | | | | | | |
| (B5) Matrix | — | — | 12 | — | 19 | — | — | — |
| copolymer | | | | | | | | |
| (parts by weight) | | | | | | | | |
| (C) PMMA | 68 | 38 | — | 18 | 49 | 18 | — | — |
| (parts by weight) | | | | | | | | |
| (D) Black dye | 1 | 1 | 1 | 1 | 1 | 1 | 1 | 1 |
| (parts by weight) | | | | | | | | |
| Izod impact | 7.7 | 7.9 | 9.0 | 7.4 | 7.0 | 8.3 | 4.9 | 12. |
| strength (kJ/m²) | | | | | | | | 0 |
| Flowability index | 4.6 | 6.2 | 7.5 | 6.0 | 5.5 | 4.9 | 10.2 | 7.7 |
| (g/10 min) | | | | | | | | |
| Heat deflection | 78 | 82 | 82 | 80 | 75 | 84 | 84 | 82 |
| temperature (° C.) | | | | | | | | |
| Degree of | 4.5 | 6.0 | 3.3 | 2.6 | 2.2 | 7.0 | 2.3 | 6.5 |
| blackness | | | | | | | | |
| (L, SCE) | | | | | | | | |

TABLE 3

| | Comparative Example | | | | | | | |
|---|---|---|---|---|---|---|---|---|
| Division | 9 | 10 | 11 | 12 | 13 | 14 | 15 | 16 |
| (A1) Graft | 5 | 5 | — | — | — | — | — | — |
| copolymer | | | | | | | | |
| (parts by weight) | | | | | | | | |
| (A2) Graft | — | — | — | — | — | — | — | — |
| copolymer | | | | | | | | |
| (parts by weight) | | | | | | | | |
| (A3) Graft | — | — | — | — | — | 40 | 40 | 40 |
| copolymer | | | | | | | | |
| (parts by weight) | | | | | | | | |
| (A4) Graft | 30 | 30 | 40 | 40 | 40 | — | — | — |
| copolymer | | | | | | | | |
| (parts by weight) | | | | | | | | |
| (B1) Matrix | — | — | 60 | — | — | 60 | — | — |
| copolymer | | | | | | | | |
| (parts by weight) | | | | | | | | |
| (B2) Matrix | 65 | — | — | — | — | — | — | — |
| copolymer | | | | | | | | |
| (parts by weight) | | | | | | | | |
| (B3) Matrix | — | 65 | — | — | — | — | — | — |
| copolymer | | | | | | | | |
| (parts by weight) | | | | | | | | |
| (B4) Matrix | — | — | — | — | — | — | — | — |
| copolymer | | | | | | | | |
| (parts by weight) | | | | | | | | |
| (B5) Matrix | — | — | — | 60 | — | — | 60 | — |
| copolymer | | | | | | | | |
| (parts by weight) | | | | | | | | |
| (C) PMMA | — | — | — | — | 60 | — | — | 60 |
| (parts by weight) | | | | | | | | |
| (D) Black dye | 1 | 1 | 1 | 1 | 1 | 1 | 1 | 1 |
| (parts by weight) | | | | | | | | |
| Izod impact | 5.1 | 7.2 | 3.6 | 2.4 | 3.5 | 3.9 | 3.8 | 4.2 |
| strength (kJ/m²) | | | | | | | | |
| Flowability index | 7.5 | 8.5 | 6.6 | 6.8 | 3.5 | 6.9 | 6.9 | 3.2 |
| (g/10 min) | | | | | | | | |
| Heat deflection | 78 | 83 | 82 | 74 | 76 | 84 | 75 | 78 |
| temperature (° C.) | | | | | | | | |
| Degree of | 1.8 | 5.5 | 1.2 | 0.4 | 0.9 | 3.7 | 1.1 | 0.7 |
| blackness | | | | | | | | |
| (L, SCE) | | | | | | | | |

As shown in Tables 1 to 3, it could be confirmed that the resin compositions of the present disclosure (Examples 1 to 7) may accomplish a high degree of blackness as well as improved heat resistance, flowability and impact resistance in contrast to Comparative Examples 1 to 8.

In case of Comparative Example 3 using a graft copolymer including an acrylic polymer having an average particle diameter of greater than 100 nm, it could be confirmed that the degree of blackness was markedly degraded in contrast to Examples 1 to 7.

In case of Comparative Example 4 using a PMMA resin as well as a matrix copolymer including an alkyl-substituted aromatic vinyl-based monomer unit, an alkyl (meth)acrylate monomer unit and a vinylcyan-based monomer unit, as a matrix resin, it could be confirmed that the flowability index was markedly degraded in contrast to Examples 1 to 7.

In case of Comparative Example 1 using a graft copolymer including an acrylic polymer having an average particle diameter of greater than 100 nm and using a PMMA resin other than a matrix copolymer including an alkyl-substituted aromatic vinyl-based monomer unit, an alkyl (meth)acrylate monomer unit and a vinylcyan-based monomer unit, as a matrix resin, it could be confirmed that the flowability index and the degree of blackness were markedly degraded in contrast to Examples 1 to 7.

In case of Comparative Example 2 using a graft copolymer including an acrylic polymer having an average particle diameter of greater than 100 nm and using a PMMA resin as well as a matrix copolymer including an alkyl-substituted aromatic vinyl-based monomer unit, an alkyl (meth)acrylate monomer unit and a vinylcyan-based monomer unit, as a matrix resin, it could be confirmed that the flowability index and the degree of blackness were markedly degraded in contrast to Examples 1 to 7.

In case of Comparative Example 5 not using a matrix copolymer including an alkyl-substituted aromatic vinyl-based monomer unit, an alkyl (meth)acrylate monomer unit and a vinylcyan-based monomer unit but using a matrix copolymer including an alkyl-unsubstituted aromatic vinyl-based monomer unit, an alkyl (meth)acrylate monomer unit and a vinylcyan-based monomer unit and a PMMA resin, as matrix resins, it could be confirmed that the flowability index and heat resistance were markedly degraded in contrast to Examples 1 to 7.

In case of Comparative Example 6 using an AMS-AN copolymer and a PMMA resin, as matrix resins, it could be confirmed that the flowability index and the degree of blackness were markedly degraded in contrast to Examples 1 to 7.

In case of Comparative Example 7 using a matrix copolymer including an alkyl-substituted aromatic vinyl-based monomer unit, an alkyl (meth)acrylate monomer unit and a vinylcyan-based monomer unit in greater than 70 parts by weight, as a matrix resin, it could be confirmed that the impact strength and the flowability index were markedly degraded in contrast to Examples 1 to 7.

In case of Comparative Example 8 including a graft copolymer including an acrylic polymer having an average particle diameter of 200 nm to 650 nm in greater than 15 parts by weight, and including a graft copolymer including an acrylic polymer having an average particle diameter of 50 nm to 100 nm in 16 parts by weight or less, it could be confirmed that the degree of blackness was markedly degraded in contrast to Examples 1 to 7.

In case of Comparative Example 9 using a matrix copolymer including an alkyl-substituted aromatic vinyl-based monomer unit, an alkyl (meth)acrylate monomer unit and a vinylcyan-based monomer unit as a matrix resin, but using the alkyl (meth)acrylate monomer unit in greater than 50 wt %, it could be confirmed that the impact strength was markedly degraded in contrast to Example 1.

In case of Comparative Example 10 using a matrix copolymer including an alkyl-substituted aromatic vinyl-based monomer unit, an alkyl (meth)acrylate monomer unit and a vinylcyan-based monomer unit as a matrix resin, but using the alkyl-substituted aromatic vinyl-based monomer unit in greater than 40 wt %, it could be confirmed that the degree of blackness was markedly degraded in contrast to Example 1.

In cases of Comparative Examples 11 to 16 not including a graft copolymer including an acrylic polymer having an average particle diameter of 300 nm to 650 nm, it could be confirmed that the impact strength was markedly degraded in contrast to Examples 1 to 7.

Hereinabove, although the present disclosure has been described with reference to exemplary embodiments, the present disclosure is not limited thereto, but may be variously modified and altered by those skilled in the art to which the present disclosure pertains without departing from the spirit and scope of the present disclosure claimed in the following claims.

1. A resin composition comprising:
a graft copolymer; and
a matrix copolymer,
wherein the graft copolymer comprises:
a first graft copolymer comprising an acrylic polymer having an average particle diameter of 200 nm to 650 nm, an aromatic vinyl-based monomer unit and a vinylcyan-based monomer unit; and
a second graft copolymer comprising an acrylic polymer having an average particle diameter of 50 nm to 100 nm, an aromatic vinyl-based monomer unit and a vinylcyan-based monomer unit,
the matrix copolymer comprises a first matrix copolymer comprising an alkyl-substituted aromatic vinyl-based monomer unit, an alkyl (meth)acrylate monomer unit, and a vinylcyan-based monomer unit, and
the first graft copolymer is comprised in 1 part by weight to 15 parts by weight, the second graft copolymer is comprised in 16 parts by weight to 40 parts by weight, and the first matrix copolymer is comprised in 40 parts by weight to 70 parts by weight, based on 100 parts by weight of the graft copolymer and the matrix copolymer.

2. The resin composition of claim 1, wherein a refractive index difference between the second graft copolymer and the first matrix copolymer is 0.1 or less.

3. The resin composition of claim 1, wherein a refractive index difference between the second graft copolymer and the first matrix copolymer is 0.02 or less.

4. The resin composition of claim 1, wherein based on the weight of the first matrix copolymer itself, the first matrix copolymer comprises:
the alkyl-substituted aromatic vinyl-based monomer unit in 35 wt % to 40 wt %,
the alkyl (meth)acrylate monomer unit in 40 wt % to 50 wt %, and
the vinylcyan-based monomer unit in 17 wt % to 22 wt %.

5. The resin composition of claim 4, wherein the first matrix copolymer includes a copolymer of α-methylstyrene, methyl methacrylate, and acrylonitrile.

6. The resin composition of claim 1, wherein the matrix copolymer further comprises a second matrix copolymer comprising an alkyl-unsubstituted aromatic vinyl-based monomer unit, an alkyl (meth)acrylate monomer unit and a vinylcyan-based monomer unit.

7. The resin composition of claim 6, wherein the second matrix copolymer is comprised in 5 parts by weight to 30 parts by weight based on 100 parts by weight of the graft copolymer and the matrix copolymer.

8. The resin composition of claim 7, wherein the second matrix copolymer includes a copolymer of styrene, methyl methacrylate and acrylonitrile.

9. The resin composition of claim 1, further comprising a colorant.

10. The resin composition of claim 9, wherein the colorant comprises a mixture of anthraquinone and perinone.

11. The resin composition of claim 1, wherein the resin composition does not comprise an alkyl (meth)acrylate polymer.
